(19) United States
(12) Patent Application Publication
(10) Pub. No.: US 2017/0270341 A1
(43) Pub. Date: Sep. 21, 2017

(54) THIN TYPE FINGERPRINT RECOGNITION DEVICE WITH OPTICAL FILTER STRUCTURE

(71) Applicant: CentraLED Technology Co., Ltd., Taoyuan (TW)

(72) Inventors: Ching-Cherng SUN, Taoyuan (TW); Yeh-Wei YU, Taoyuan (TW); Liang-Zhu YU, Taoyuan (TW)

(73) Assignee: CentraLED Technology Co., Ltd.

(21) Appl. No.: 15/373,851

(22) Filed: Dec. 9, 2016

Related U.S. Application Data
(60) Provisional application No. 62/309,515, filed on Mar. 17, 2016.

(51) Int. Cl. G06K 9/00

(52) U.S. Cl. CPC G06K 9/0004; G06K 9/00087

(57) ABSTRACT

The present invention discloses thin type fingerprint recognition devices with optical filter structure, it includes a transparent layer, an optical film and an optical sensor, wherein the optical film is formed on a first surface in an embodiment, and is formed on a second surface in another embodiment. With the implementation of the present invention, complex production process or equipments are not required for producing fingerprint recognition devices and reduces costs of production; the size of the fingerprint recognition device is reduced, a variety of thickness choices for transparent layer and more applications are thus possible; and the directivity and the contrast of fingerprint signal is enhanced thus enables making clearer features and characteristics of the fingerprint signal and thus the recognition accuracy of fingerprints.

### BACKGROUND OF THE INVENTION

1. Technical Field

The present invention relates to fingerprint recognition devices, and more particularly to thin type fingerprint recognition devices with optical filter structure.

2. Description of Related Art

For the purpose of obtaining clear images, an imaging system is usually adopted in traditional fingerprint recognition systems or apparatus. Besides, due to enough space occupied, a positive lens is used in the imaging system for imaging purpose.

However, as fingerprint recognition becomes more and more popular in handheld devices or mobile devices nowadays, the reserved space for fingerprint recognition is becoming strictly limited.

Imaging methods using positive lens cannot therefore be applied in such limited space when using in the small space reserved in small appliances.

In view of this, we propose a thin fingerprint recognition device with optical filter structure and with high imaging quality to not only adequate for applications in limited space inside thin devices, ultra thin devices, mini devices or smart mobile devices, but is able to enhance the contrast of fingerprint signal to increase the discrimination of characteristics and reduce the ratio of false recognition.

### BRIEF SUMMARY OF THE INVENTION

The present invention discloses thin type fingerprint recognition devices with optical filter structure, it includes a transparent layer, an optical film and an optical sensor, wherein the optical film is formed on a first surface in an embodiment, and is formed on a second surface in another embodiment. With the implementation of the present invention, complex production process or equipments are not required for producing fingerprint recognition devices and reduces costs of production; the size of the fingerprint recognition device is reduced, a variety of thickness choices for transparent layer and more applications are thus possible; and the directivity and the contrast of fingerprint signal is enhanced thus enables making clearer features and characteristics of the fingerprint signal and thus the recognition accuracy of fingerprints.

The present invention provides a high resolution thin device for fingerprint recognition, used to sense or recognize a fingerprint, comprising: a transparent layer, being made of light transmitting substance, has a first surface and a second surface opposite to the first surface; an optical film, formed on the second surface; and an optical sensor, being fixedly provided beside the optical film; wherein the fingerprint being in contact with the first surface.

The present invention further provides another thin type fingerprint recognition device with optical filter structure, used to sense or recognize a fingerprint, comprising: a transparent layer, being made of light transmitting substance, has a first surface and a second surface opposite to the first surface; an optical film, being formed on the first surface; and an optical sensor, being fixedly provided beside the optical film; wherein the fingerprint to be sensed or recognized being in contact with the optical film.

Implementation of the present invention at least provides the following advantageous effects:

1. Structure simplicity to improve ease of manufacturing and low manufacturing costs.

2. Reduction of space occupation enabling further applications.

3. High resolution to adequately classify or recognize fingerprint.

4. Capable of enhancing the contrast of fingerprint signal to increase the discrimination of characteristics and reduce the ratio of false recognition.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a thin type fingerprint recognition device with optical filter structure in an embodiment of the present invention.

FIG. 2 is a perspective view of fingerprint signal reflected by a fingerprint generates different reflecting signal intensities by normal incident light and inclined incident light in the embodiment of FIG. 1.

FIG. 3A is a perspective view of a thin type fingerprint recognition device with optical filter structure further comprises a pillar layer in an embodiment of the present invention.

FIG. 3B is a perspective view of a pillar layer in an embodiment of the present invention.

FIG. 3C is a perspective view of a pillar layer in another embodiment of the present invention.

FIG. 4 is a perspective view of fingerprint signal reflected by a fingerprint generates different reflecting signal intensities by normal incident light and inclined incident light in the embodiment of FIG. 3A of the present invention.

FIG. 5 is a perspective view of a thin type fingerprint recognition device with optical filter structure in another embodiment of the present invention.

FIG. 6 is a perspective view of a thin type fingerprint recognition device with optical filter structure further comprises a pillar layer in the embodiment of FIG. 5 of the present invention.

FIG. 7 is a representative graph of the relationship between the transmittance and the incident angle of an incident light transmitted to an optical film in an embodiment of the present invention.

### DETAILED DESCRIPTION OF THE INVENTION

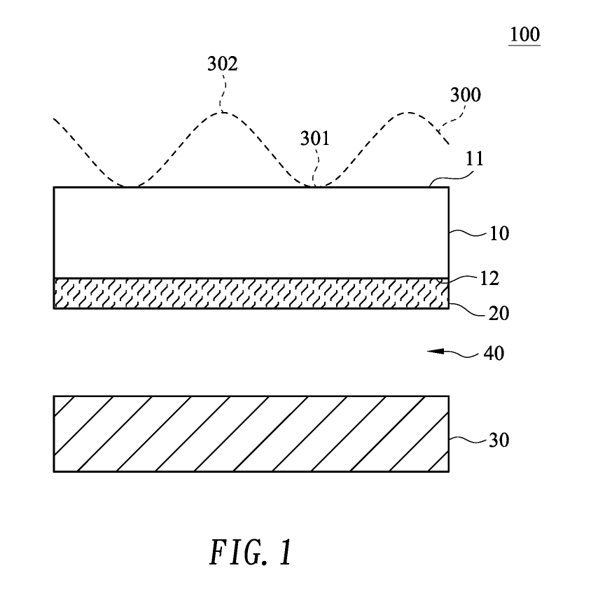

Please refer to FIG. 1, a thin type fingerprint recognition device with optical filter structure 100, being used to sense or recognize a fingerprint, in an embodiment of the present invention includes a transparent layer 10, an optical film 20, and an optical sensor 30.

As shown in FIG. 1, the transparent layer 10 includes a first surface 11 and a second surface 12 opposite to the first surface 11. And the transparent layer 10 can be a transparent plate or a transparent film made of glass or any transparent material that is transparent to visible light, light in infrared region or light in ultraviolet region.

In applications of fingerprint recognition or fingerprint detection, the thickness of the transparent layer being in the range from 1 μm to 300 μm, or in the range from 300 μm to 500 μm.

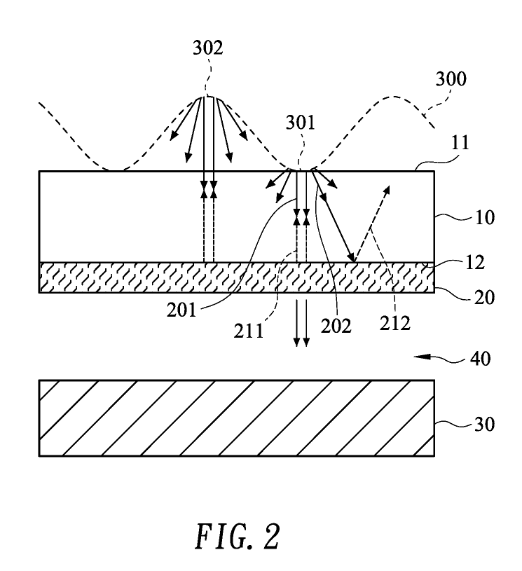

As shown in FIG. 1 and FIG. 2, when in applications, the finger with the fingerprint 300 to be detected or recognized rests on the transparent layer 10 and contacts with the first surface 11. The light reflected by at least one ridge portion 301 or at least one valley portion 302 of the finger print 300 passes through the cover layer 10 and reaches the optical film 20.

Further, the light reflected from the finger print 300 can be divided into normal direction incident light signal 201 and oblique incident light signal 202, wherein the normal direction incident light signal 201 is the light reflected from the finger print 300 and incidents vertically to the optical film 20, while the oblique incident light signal 202 is the light reflected from the finger print 300 and incidents with an angle relative to the normal (vertical) direction toward the optical film 20.

As shown in FIG. 1 and FIG. 2, the optical film 20, which is formed on the second surface 12 of the transparent layer 10, serves as a spatial directional filter in the thin fingerprint recognition device with optical filter structure 100.

Most of the normal direction incident light signal 201 incidenting to the optical film 20 passes through the optical film 20 and reaches the optical sensor 30. That means only little portion of the normal direction incident light signal 201 is reflected as a normal reflected light signal 211 by the optical film 20.

While at the same time, most of the oblique incident light signal 202 incidents to the optical film 20 is reflected as an oblique reflected light signal 212, and only little portion of it reaches the optical sensor 30.

The optical film 20 in the embodiments can be a thin film that conducts mirror reflection (Specular scattering), random reflection (Lambertian scattering), or forward scattering and backward scattering at the same time with a performance in between Specular scattering and Lambertian scattering.

Further, the reflectivity of normal direction incident light or inclined incident light to the optical film 20 being a function of wavelength, making normal direction incident light in the working frequency has small reflectivity, while inclined incident light has larger reflectivity, thus noise signal received by the optical sensor is reduced.

In an embodiment, with the implementation of the optical film 20, more than 50% of the normal direction incident light signal 201 passes through the optical film 20, that is to say, the intensity of the normal reflected light signal 211 is less than 50% of the normal direction incident light signal 201. While more than 50% of the oblique incident light signal 202 is reflected by the optical film 20 or the intensity of the oblique reflected light signal 212 is more than 50% of the oblique incident light signal 202.

Further, with proper selections for the structure of the optical film 20, the reflectivity of an inclined incident light 202 with incident angle in between −50 degree to +50 degree is greater than 25%.

Or the optical film 20 can also be formed such that the reflectivity of an inclined incident light 202 with incident angle in between −50 degree to +50 degree is greater than 50%.

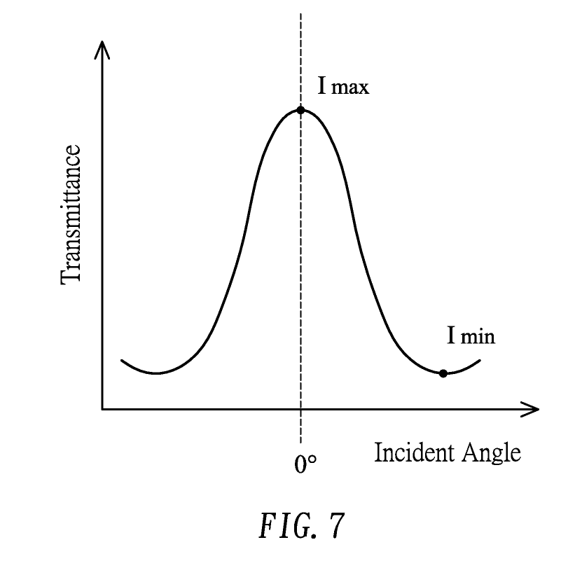

On the other side, as can be seen in FIG. 7, the optical film 20 can also be formed such that the maximum penetrating rate, denoted as Imax, through the optical film 20 of inclined incident light 202 with incident angle between −10 degree to +10 degree is at least twice the minimum penetrating rate, denoted as Imin, through the optical film of inclined incident light with incident angle between −80 degree to +80 degree.

While in another embodiment, the optical film 20 can also be formed such that the maximum penetrating rate, denoted as Imax, through the optical film 20 of inclined incident light 202 with incident angle between −10 degree to +10 degree is at least twice the minimum penetrating rate, denoted as Imin, through the optical film of inclined incident light with incident angle between −50 degree to +50 degree.

Thus the contrast of fingerprint signal is enhanced to increase the discrimination of characteristics and reduce the ratio of false recognition.

With proper selections for the structure of the optical film 20, the aforesaid 50% value of reflectivity can be modified to a value in the range from 50% to 99%. That is to say, 50%-99% of the normal direction incident light signal 201 penetrates the optical film 20, while 50%-99% of the oblique incident light signal 202 is reflected or blocked by the optical film 20.

Therefore, oblique incident light signal 202 reflected from the fingerprint 300 is reflected or blocked by the optical film 20 reducing the total amount of light intensity penetrating the optical film 20 to reduce noise signal and raising the contrast of fingerprint signal received by the optical sensor 30.

With this, blur effect by the scattering of the light signal toward the optical sensor 30 reflected by at least one ridge 301 or valley 302 of the finger print 300 can be reduced or even eliminated.

With continuing reference to FIG. 1 and FIG. 2, there can be a spacing gap 40 between the optical film 20 and the optical sensor 30 of the thin fingerprint recognition device with optical filter structure 100.

Different amount of spacing gap 40 can be chosen according to different applications, the spacing gap 40 can be chosen in between 0 mm to 5 mm in general, while at the same time, the spacing gap 40 can be just a gap filled with thin air or a gap that is filled with optical glue.

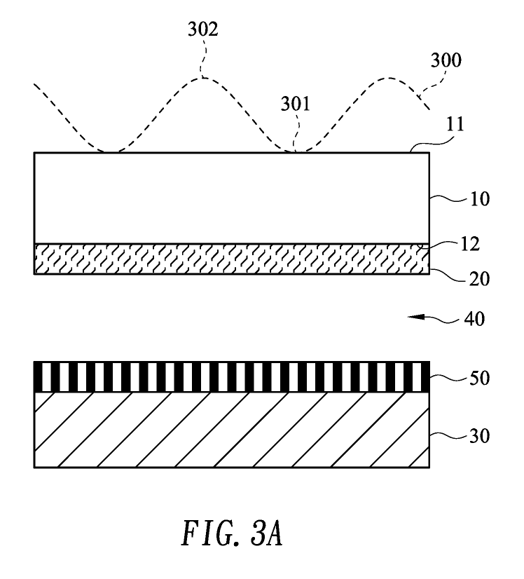

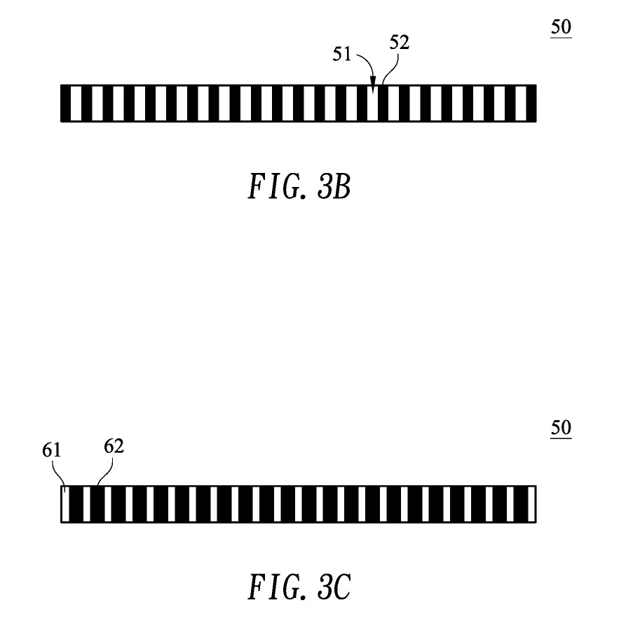

Please refer to FIG. 3A, a pillar layer 50 can be formed in between the optical film 20 and the optical sensor 30 of the thin fingerprint recognition device with optical filter structure 100.

As shown in FIG. 3A and FIG. 3B, pillar layer 50 being connected with the optical sensor 30 and being in between the optical film 20 and the optical sensor 30, can be formed as non-transparent filler material 52 with plural cylindrical through holes 51.

With this, part of the light signal penetrating through the cover plate 20 is blocked by the non-transparent filler material 52 when other part of the light signal penetrates through the cylindrical through holes 51, thus further reducing oblique incident light signal 202 and raising the contrast of the optical signal reflected by the finger print 300.

Wherein a transparent material or transparent materials can be filled in the cylindrical through holes 51 to make the pillar layer 50 better endurable while the light still passes through the cylindrical through holes 51.

On the other hand, the diameter of the cylindrical through holes 51 can be chosen to be greater than 2 μm or in between 2 μm and 100 μm.

Further, as shown in FIG. 3C, the pillar layer 50 can also be formed by plural silicon oxide (SiO2) rods 61, wherein any space between any two rods 61 is filled with non-transparent filler material 62, and the transmittance of light of the non-transparent filler material 62 can be chosen in the value between 0.01% to 30% .

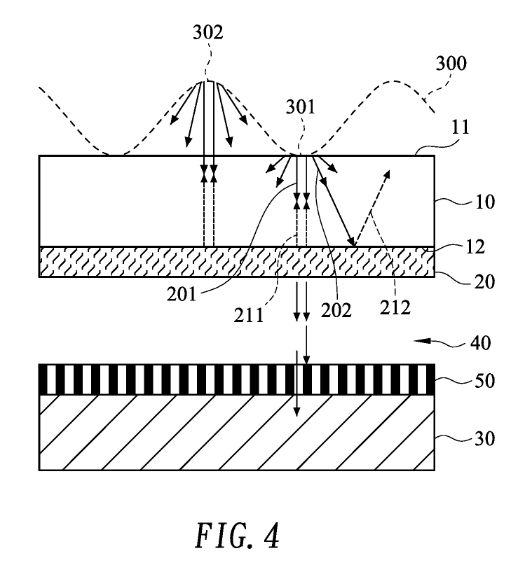

Please refer further to FIG. 1, FIG. 2 and FIG. 4, the optical sensor 30 is to receive and sense the light signal reflected from at least one ridge 301 and at least one valley 302 of the finger print 300 passes through the transparent layer 10 and the optical filter 20, and generates a finger print pattern signal for post processing.

Wherein the aforesaid optical sensor 30 can be composed of at least one optical sensor chip or group of optical sensor chips.

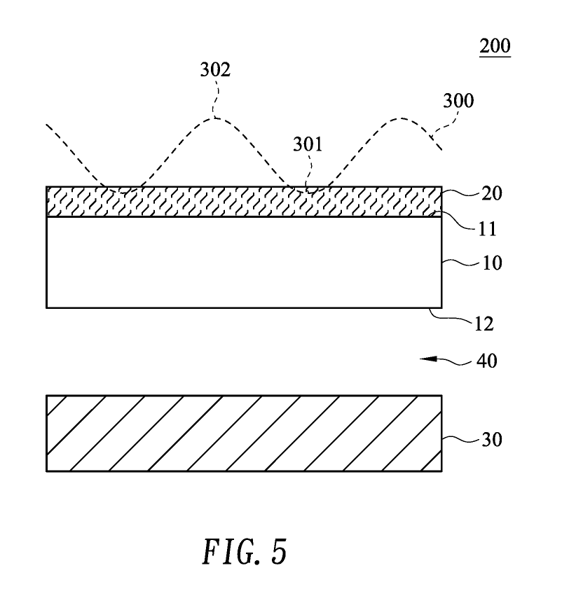

Referring to FIG. 5, an embodiment of a thin fingerprint recognition device with optical filter structure 200 includes a transparent layer 10, an optical film 20 and an optical sensor 30.

As shown in FIG. 5, the optical film 20 of the embodiment is being on the first surface 11 of the transparent layer 10, wherein the optical characteristics of the optical film 20 being reflecting signal in specific spectrum range while being a film with high reflectivity in said specific spectrum range.

As shown in FIG. 5, the optical film 20 being on the first surface 11 of the transparent layer 10, the ridge portion 301 of the fingerprint 300 is in contact with the optical film 20, and the light signal reflected from the ridge portion 301 penetrates the optical film 20 and enters the transparent layer, while the valley portion 302 of the fingerprint 300 that does not in contact with the optical film 20 is reflected due to higher reflectivity of its being an oblique incident light signal 202. Thus the contrast of the fingerprint signal is enhanced and performance of recognition is increased.

Except the feature of the optical film 20 being on the first surface 11 of the transparent layer 10, the technical features of the transparent layer 10, optical film 20, optical sensor 30 and spacing gap 40 of the thin fingerprint recognition device with optical filter structure 200 is same as those of the thin fingerprint recognition device with optical filter structure 100.

As shown in FIG. 5, the key feature of the optical film 20 being on the first surface 11 of the transparent layer 10 is in that: the light signal reflected by the ridge portion 301 which contacts the optical film 20 penetrates through the optical film 20 and enters the transparent layer 10; while the light reflected by the valley portion 302 which being not in touch with the optical film 20 will be reflected by the optical film 20 due to high reflectivity of being an oblique incident light signal 202, Thus the contrast and visibility of the fingerprint signal reflected by the finger print 300 is enhanced and performance of recognition is increased.

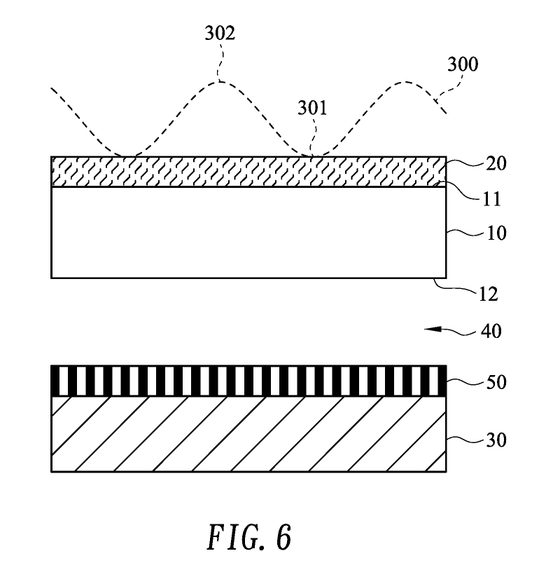

Moreover, as shown in FIG. 6, there can also be a pillar layer 50 in between the transparent layer 10 and the optical sensor 30 of the thin fingerprint recognition device with optical filter structure 200.

The technical feature of the said pillar layer 50 is same as that of the pillar layer 50 of the thin fingerprint recognition device with optical filter structure 100.

All in all, with implementation of the optical filter 20, thin fingerprint recognition device with optical filter structure 100 or thin fingerprint recognition device with optical filter structure 200 has the benefits of occupying less space to enable further applications, having high resolution to adequately classify or recognize fingerprint, and with the optical film 20 being capable of enhancing the contrast of fingerprint signal to increase the discrimination of characteristics and reduce the ratio of false recognition.

With further implementation of the pillar layer 50 on above the optical sensor 30, oblique incident light signal 202 can be further suppressed or isolated or blocked to further enhance the contrast of the finger print signal.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A thin type fingerprint recognition device with optical filter structure, used to sense or recognize a fingerprint, comprising:
a transparent layer, being made of light transmitting substance, has a first surface and a second surface opposite to the first surface;
an optical film, being formed on the second surface; and
an optical sensor, being fixedly provided beside the optical film;
wherein the fingerprint to be sensed or recognized being in contact with the first surface.

2. The thin type fingerprint recognition device of claim 1, wherein a spacing gap being in between the optical film and the optical sensor.

3. The thin type fingerprint recognition device of claim 1, wherein the transparent layer is being penetrated by visible light, infrared light or ultraviolet light.

4. The thin type fingerprint recognition device of claim 1, wherein the thickness of the transparent layer being in the range from 1 μm to 300 μm, or in the range from 300 μm to 500 μm.

5. The thin type fingerprint recognition device of claim 1, wherein a pillar layer being further formed in between the optical film and the optical sensor, and wherein the pillar layer being a non-transparent filler material with plural cylindrical through holes.

6. A thin type fingerprint recognition device with optical filter structure, used to sense or recognize a fingerprint, comprising:
a transparent layer, being made of light transmitting substance, has a first surface and a second surface opposite to the first surface;
an optical film, being formed on the first surface; and
an optical sensor, being fixedly provided beside the optical film;
wherein the fingerprint to be sensed or recognized being in contact with the optical film.

7. The thin type fingerprint recognition device of claim 6, wherein a spacing gap being in between the second surface and the optical sensor.

8. The thin type fingerprint recognition device of claim 6, wherein the transparent layer is being penetrated by visible light, infrared light or ultraviolet light.

9. The thin type fingerprint recognition device of claim 6, wherein the thickness of the transparent layer being in the range from 1 μm to 300 μm, or in the range from 300 μm to 500 μm.

10. The thin type fingerprint recognition device of claim 6, wherein a pillar layer being further formed in between the second surface and the optical sensor, wherein the pillar layer being a non-transparent filler material with plural cylindrical through holes.

11. The thin type fingerprint recognition device of claim 1, wherein a pillar layer being further formed in between the optical film and the optical sensor, and wherein the pillar layer being formed by plural silicon oxide (SiO2) rods, wherein any space between any two rods is filled with non-transparent filler material.

12. The thin type fingerprint recognition device of claim 1, wherein the optical film is formed such that the reflectivity of an inclined incident light with incident angle in between −50 degree to +50 degree is greater than 25%.

13. The thin type fingerprint recognition device of claim 1, wherein the optical film is formed such that the reflectivity of an inclined incident light with incident angle in between −50 degree to +50 degree is greater than 50%.

14. The thin type fingerprint recognition device of claim 1, wherein the maximum penetrating rate through the optical film of inclined incident light with incident angle between −10 degree to +10 degree is at least twice the minimum penetrating rate through the optical film of inclined incident light with incident angle between −80 degree to +80 degree.

15. The thin type fingerprint recognition device of claim 1, wherein the maximum penetrating rate through the optical film of inclined incident light with incident angle between −10 degree to +10 degree is at least twice the minimum penetrating rate through the optical film of inclined incident light with incident angle between −50 degree to +50 degree.

16. The thin type fingerprint recognition device of claim 6, wherein a pillar layer being further formed in between the second surface and the optical sensor, and wherein the pillar layer being formed by plural silicon oxide (SiO2) rods, wherein any space between any two rods is filled with non-transparent filler material.

17. The thin type fingerprint recognition device of claim 6, wherein the optical film is formed such that the reflectivity of an inclined incident light with incident angle in between −50 degree to +50 degree is greater than 25%.

18. The thin type fingerprint recognition device of claim 6, wherein the optical film is formed such that the reflectivity of an inclined incident light with incident angle in between −50 degree to +50 degree is greater than 50%.

19. The thin type fingerprint recognition device of claim 6, wherein the maximum penetrating rate through the optical film of inclined incident light with incident angle between −10 degree to +10 degree is at least twice the minimum penetrating rate through the optical film of inclined incident light with incident angle between −80 degree to +80 degree.

20. The thin type fingerprint recognition device of claim 6, wherein the maximum penetrating rate through the optical film of inclined incident light with incident angle between −10 degree to +10 degree is at least twice the minimum penetrating rate through the optical film of inclined incident light with incident angle between −50 degree to +50 degree.
